(19) United States
(12) Patent Application Publication
(10) Pub. No.: US 2025/0330434 A1
(43) Pub. Date: Oct. 23, 2025

(54) Location-based secure end-to-end messaging system

(71) Applicant: Anup Kattel, Leumeah (AU)

(72) Inventor: Anup Kattel, Leumeah (AU)

(21) Appl. No.: 18/384,816

(22) Filed: Oct. 27, 2023

Related U.S. Application Data
(63) Continuation-in-part of application No. 17/984,231, filed on Nov. 9, 2022, now Pat. No. 11,805,090.
(60) Provisional application No. 63/277,575, filed on Nov. 9, 2021.

(30) Foreign Application Priority Data
Apr. 8, 2023 (AU) 2023902468

(51) Int. Cl. H04L 51/04; G06F 21/60; H04L 9/08

(52) U.S. Cl. CPC H04L 51/04; G06F 21/602; H04L 9/0825

(57) ABSTRACT

A secure end-to-end messaging system utilizes location-based computer readable media encoding cryptographic codes to facilitate encryption and decryption of messages between electronic devices. A first device reads a cryptographic code from a first media, encrypts a message, and transmits it to a server where only the ciphertext is stored. A second device, at a different location, reads a second cryptographic code from a paired media to decrypt the message locally. The codes represent symmetric keys or asymmetric key pairs, enabling message authenticity verification through digital signatures. Cryptographic data embedded in URL fragments to avoid transmission to the server, enhancing security against interception. The media also encodes permissions, expiration dates, and device identifiers for granular control and notification capabilities. The system supports hierarchical access, group messaging, and various formats including audio/video, ensuring scalable, secure, and verifiable communication across distributed users without exposing plain text or private keys to the server.

### FIELD OF THE INVENTION

This invention relates generally to a type of secure messaging system.

### SUMMARY OF THE DISCLOSURE

There is provided herein a secure end-to-end messaging system comprising first computer readable media in a first location encoding a first cryptographic code.

The system also comprises second computer readable media associated with the first computer readable media in a second location away from the first location and encoding a second cryptographic code.

The first cryptographic code may be the same as the second cryptographic code (i.e., being a shared password or a symmetric key) or be cryptographically associated with the second cryptographic code (such as an asymmetric key pair).

The system further comprises a server.

A first electronic device is configured to read the first cryptographic code and receive a message via a user interface thereof.

The system is configured to encrypt the message to generate an encrypted message using the first cryptographic code and to store the encrypted message on the server.

A second electronic device is configured to read the second cryptographic code and the system is configured to decrypt the encrypted message using the second cryptographic code so that the message can be displayed on the user interface thereof of the second electronic device.

Preferably the encryption and decryption is done at the first and second electronic devices respectively. In this regard, the first electronic device may encrypt the message and transmit the encrypted message to the server and the second electronic device can retrieve the encrypted message from the server for decryption. As such, the server never stores the message in plaintext.

In embodiments, the computer readable media may encode a URL of a resource served by the server and wherein the cryptographic key forms a fragment thereof. As such, the cryptographic key is never transmitted to the server.

However, the URL may comprise query string parameters which may encode permission settings, message expiry dates and the like, which is transmitted to the server.

The cryptographic key may take the form of a group password and wherein both the first and second computer readable media encode the group password. Normally the computer readable media are paired although more than two computer readable media each encoding the group password are envisaged.

In embodiments, an asymmetric key pair may be used to cryptographically sign the encrypted messages by the devices using respective exclusive private key before transmitting them to the server. Either the server or the other computer readable media would hold the corresponding public key in order to verify the signature of the messages for the authenticity. Each computer readable media would require an asymmetric key pair and would encode the private key in the media for signing the messages they transmit.

The first and second computer readable media may further encode a group identifier which may be used by the server as a primary key to reduce database query look up times to retrieve messages.

In embodiments, only the first computer readable media encodes a master password which is used to enable permission settings, such as message part editing permissions, message type sending permissions and the like.

For example, the first computer readable media having the master password may allow the first electronic device to edit both the message header and a body and to initiate a new message whereas the second computer readable media without the master password may only allow the second electronic device to reply to the message and only edit the body thereof.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a secure end-to-end messaging system In accordance with an embodiment; and

FIG. 2 shows exam pre-processing of the system in accordance with an embodiment.

### DESCRIPTION OF EMBODIMENTS

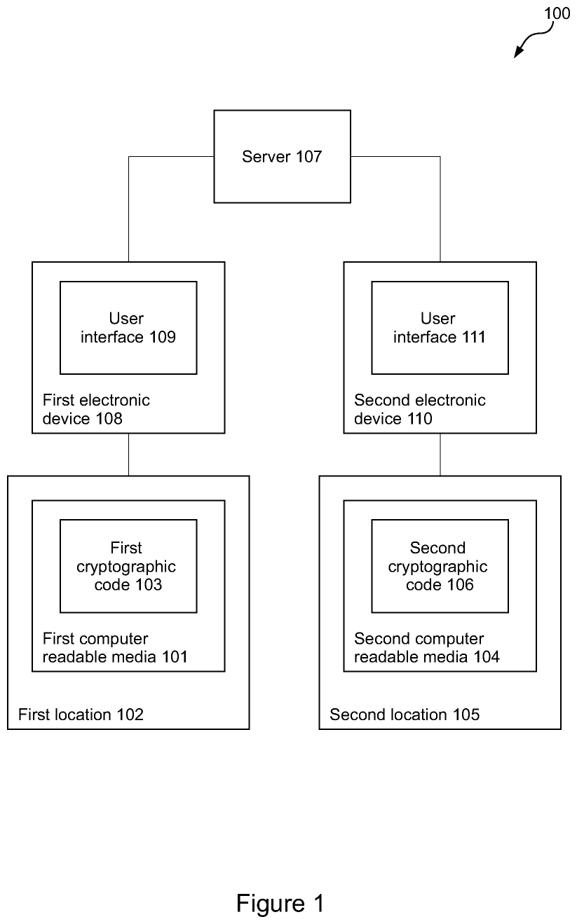

FIG. 1 shows a secure end-to-end messaging system 100 comprising a first computer readable media 101 in a first location 102.

The first computer readable media encodes a first cryptographic code 103.

The system 100 further comprises a second computer readable media 104 associated with the first computer readable media 101. The second computer readable media 104 is at a second location 105. The second location 105 may be some distance from the first location 102.

The second computer readable media 104 encodes a second cryptographic code 106.

The computer readable media 101, 104 may be near field communication (NFC) or similar tags which can be read wirelessly in close proximity by an NFC reader of the electronic device 108, 110.

In alternative embodiments, the computer readable media 101, 104 may be optical computer readable media which can be optically decoded using image data obtained from an image sensor of the electronic device 108, 110.

The system 100 further comprises a server 107. The server 107 comprises a database or the like for storing encrypted messages as will be described in further detail below.

The system further comprises a first electronic device 108 having a user interface 109 and a second electronic device 110 having an associated user interface 111.

Each electronic device 108, 110 may comprise a processor for processing digital data. A memory device in operable communication with the processor via a system bus may be configured for storing digital data including computer program code instructions. In use, the processor fetches these computer program code instructions and associated data for interpretation and execution of the computational functionality described herein.

The computer program code instructions may be logically divided into a plurality of computer program code instruction controllers, such as controllers for encrypting or decrypting messages, user interface control, sending and receiving data to and from the server 107 and the like.

Each electronic device 108, 110 may have a data interface for exchanging data with the server 107 via a wide area network, such as the Internet.

Each electronic device 108, 110 may further have a digital display for the display of digital data. The digital display may be overlaid with a haptic user interface to receive user input gestures in relation to digital data displayed thereon.

Each electronic device 108, 110 may take the form of a mobile phone device having a downloaded software application installed and executing thereon.

The server 107 may further comprise the aforedescribed computer componentry including the processor, memory and data interface.

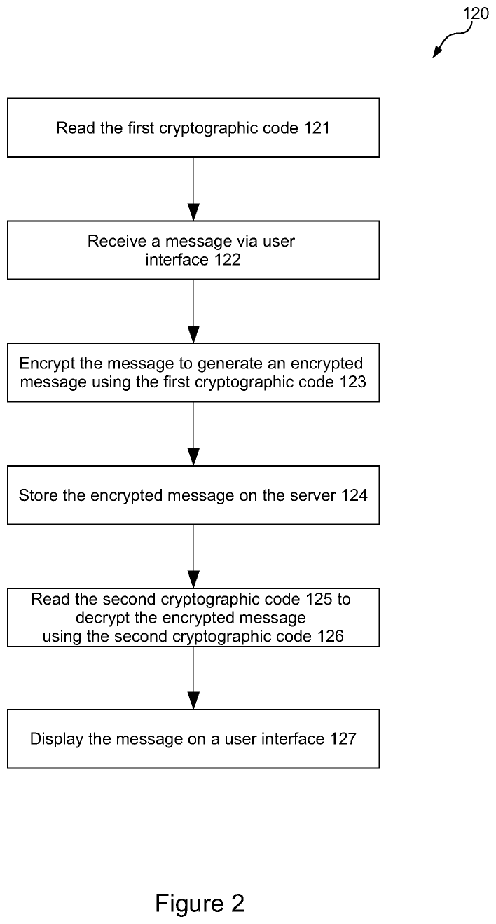

FIG. 2 shows exemplary processing 120 implement by the system 100.

At step 121, the first electronic device 108 is configured to read the first cryptographic code 103. As alluded to above, where the first computer readable media 101 takes the form of an NFC tag, the first electronic device 108 may comprise an NFC reader which is held in close proximity with the first computer readable media 101 to wirelessly read the data encoded therein.

Alternatively, where the first computer readable media 101 takes the form of an optical code, such as a two-dimensional code, the first electronic device 108 may comprise an image sensor which is held in front of the first computer readable media 101 to capture image data therefrom from which the data encoded therein is optically decoded by the first electronic device 108.

At step 122, the first electronic device 108 is configured to receive a message via the user interface 110 thereof.

For example, responsive to reading the first computer readable media 101, the first electronic device 108 may display a form in the user interface 109 wherein the message may be entered in text format. However, messages in other formats, including audio and video formats are also envisaged.

Where a software application is installed on the first electronic device 108, the software application 108 may cause the first electronic device 108 to display the form responsive to the first electronic device 108 reading the first computer readable media 101.

In alternative embodiments, the first computer readable media 101 encodes a URL of a resource served by the server 107. As such, when scanning the first computer readable media 101, a web browser application installed on the first electronic device 108 may browse to the resource wherein the server 107 would respond with an HTML form or the like for the taking of the message.

At step 123, the system 100 is configured to encrypt the message to generate an encrypted message using the first cryptographic code 123.

In embodiments, the first electronic device 101 connects to the server 107 using a secure communication channel, such as using the HTTPS protocol wherein the messages in plaintext are only encrypted using TSL and the server 107 has access to the plaintext for encryption.

However, in a preferred embodiment, the encryption is done at the first electronic device 108. In accordance with this embodiment, the first electronic device 108 is configured to encrypt the message to generate the encrypted messages using the first cryptographic code 101 and to transmit the encrypted message to the server 107.

At step 124, the server 107 stores the encrypted message, such as in the database thereof.

At step 125, at the second location 105, the second electronic device 110 is configured to read the second cryptographic code 106.

At step 126, the system 100 is configured to decrypt the encrypted message using the second cryptographic code 126.

As alluded to above, whereas the second electronic device 110 could connect to the server 107 via HTTPS protocol and wherein decryption is done at the server 107, In a preferred embodiment the decryption is done at the second electronic device 110. As such, in accordance with this embodiment, the second electronic device 110 is configured to receive the encrypted message from the server 107 and decrypt the encrypted message.

At step 127, the message may be displayed on the user interface 111 of the second electronic device 110. As alluded to above, any audio and/or visual messages may be played out by the second electronic device 110.

In embodiments, the second electronic device 110 may receive a reply message via the user interface 111 thereof wherein the system 100 is configured to encrypt the message to generate an encrypted reply message using the second cryptographic code and store the encrypted reply message on the server 107. As such, the first electronic device and then read the first cryptographic code 103 so that the system 100 is able to decrypt the encrypted reply message using the first cryptographic code and to display the reply message on the user interface 109 thereof.

In embodiments, the first cryptographic code 103 is the same as the second cryptographic code 106. In this embodiment the codes 103, 106 take the form of a shared password or a shared symmetric cryptographic key for encryption,

However, in alternative embodiments, the first cryptographic code 103 is cryptographically associated with the second cryptographic code 106 such as wherein the codes 103, 106 form a public-private key pair of an asymmetric cryptographic key pair. In embodiments, the media that encodes the private key can be used to cryptographically sign the messages so that the media that encodes the public key would be able to verify the authenticity of the message. This would result in only the media holding the private key to be able to update the messages. In further embodiments, a symmetric key pair can be used to allow encryption of the message/data that both parties can edit and for the part that only the holder of private key can edit, the shared symmetric key would be used the encrypt the data for privacy, while the private key would be used to sign the data for authenticity.

In alternative embodiments, instead of or in addition to using a symmetric key on the computer readable media 101 and 104 to allow electronic devices 108 and 110 to encrypt messages before sending to the server, two asymmetric key pairs may be used to achieve similar result. For example, the public key of one keypair would be encoded on the first computer readable media 101 to encrypt messages sent to the second electronic devices and the public key of the other keypair would be encoded on the second computer readable media 104 to encrypt messages sent to the first electronic device 108. Similarly, the corresponding private key of the public key would be encoded on the computer readable media on the other end to allow decryption of the encrypted data. This would stop attackers and unauthorised users with access to the sender computer readable media from accessing sent messages to decrypt and read because only the other computer readable media would hold the private key for decryption.

In yet other embodiments, each computer readable media may have a respective individual asymmetric key pair and store the private key of the pair in the media to sign the transmitted messages. The corresponding public key would be held by either the server or the other computer readable media to verify the authenticity of the messages. This would protect the communication from Man-In-The Middle (MITM) attacks as the private key would never be transmitted across the internet. Without asymmetric key pairs and signature verifications, a MITM attacker could encrypt the messages with their own cryptographic key rendering the messages non-decryptable and unreadable by the receiving ends.

In embodiments, the first and second computer readable media 101, 104 are grouped together wherein each of the first and second computer readable media 101, 104 may encode a group password. Normally, a pair of computer readable media are grouped in this manner although it is envisaged that more than two computer readable media may form a group by sharing a group password.

In further embodiments, the first computer readable media 101 further encodes a master password which is used for hierarchical permission settings.

For example, the master password may be used for enabling message part editing permissions such as a message header. In other words, the first computer readable media 101 having the master password could allow the first electronic device 108 to edit both a message header and a message body whereas the second computer readable media 104 without the master password can only edit the message body.

The master password may either alternatively or additionally be used for message type sending permissions such as new messages or reply messages. For example, the first computer readable media 101 having the master password could allow for the sending of new messages and reply messages whereas the second computer readable media 104 without the master password could only reply to messages, but not initiate new messages.

In some embodiments, only some computer readable media may encode the master password so that only such media has extra privileges whereas others have limited rights,

In alternative embodiments, the master password can be the private key of an asymmetric key pair allowing the computer readable medias that encode it to be able to edit and sign part of the messages or data that the non-holder can only verify with their public keys and read. This way the master password would not require to be sent to the server for verification and would reduce MITM and other attack surfaces.

In further embodiments, both the first computer readable media 101 and the second computer readable media 104 may encode a group identifier. The group identifier may be used by the server as a primary key to decrease the time required to retrieve encoded messages from the database thereof.

In further embodiments, first computer readable media 101 encodes a message expiration date and wherein the server 107 is configured to delete the encoded message at the message expiration date. For example, the first computer readable media 101 may be used to encode a message which can only be retrieved within the next 24 hours after which It is deleted.

In embodiments, the first computer readable media encodes a URL of a resource served by the server 107.

Preferably, all the cryptographic keys are represented as a fragment of the URL so that the cryptographic keys are never transmitted to the server 101 by the first electronic device 108 or the second electronic device 110.

Furthermore, the fragment may encode the group password and/or the master password.

However, the URL may comprise query string parameters which are transmitted to the server 107.

These query string parameters may encode the group identifier, language, etc.

In further embodiments, system 100 may use asymmetric keys to for signing and verifying messages. For example, the first computer readable media 101 may encode a private key of an asymmetric key pair. The private key may be used for signing the message. The second computer readable media 104 may encode the public key of the same asymmetric key pair allowing it to verify the authenticity of the message and ensure the message has not been tampered with.

In embodiments, there can be two different asymmetric key pairs with the first computer readable 101 media encoding private key of the first keypair to sign messages sent to the second computer readable media, while the second computer readable media 104 encoding the private key of the second keypair to sign messages sent to the first computer readable media 101. Both computer readable medias 101 and 104 would hold the other party's public key to verify the signature on incoming messages.

In embodiments, the server 107 may comprise the corresponding public key of the asymmetric key pair which can be used to encrypt the message and/or verify the signature of the signed message.

In alternative embodiments, the second computer readable media 104 encodes the public key. As such, when the second electronic device 110 reads the second computer readable media 104, the public key obtained therefrom can be used to encrypt the message and/or to verify the signature of the message.

In embodiments, the system 100 is configured to obtain an identifier (such as a mobile phone number, push notification identifier and the like) of the first electronic device 108 and/or the second electronic device 110 when sending or receiving the message and wherein the system 100 is configured to transmit an electronic notification of the message to the other electronic device accordingly, such as by way of push notification. For example, when a message is sent or edited from the first electronic device 108, the second electronic device receives 110 a notification and when a message is sent or edited from the second electronic device 110, the first electronic device 108 receives the notification.

In the embodiment with multiple paired computer readable media, the notification of the message from one device may be sent to all other devices in the pair or the group.

In one embodiment, the identifier of the electronic device is input via the user interface 109 of the first electronic device 108. As such, when entering a message, the user may additionally enter a mobile phone number of the second electronic device 101. As such, the system 100 may send a notification, such as a push notification or the like to the second electronic device 101 indicating that there is a message pending.

In further embodiments, the first computer readable media 101 encodes the identifier of the second electronic device 101 so that the notification can be transmitted without input via the user interface 109.

In alternative embodiments, when the sender and the receiver do not know each other's mobile number for example, the sender can use their computer readable media to configure their own mobile number and the recipients can use their computer readable media to configure their own mobile numbers for the purpose of notification. Similar configuration can be done for any other form of identifier for the notification such as push notification identifier,

The server 107 may serve a resource (such as an API or web-based interface resource) for the generation of the computer readable media 101, 104.

For example, using the resource, a user may specify the number of computer readable media and configure permission settings.

The server 107 may generate the group password and, if permission settings are required, additionally generate the master password. These permission settings may relate to the editing of message parts, the types of messages and message expiration dates or time periods.

The user may select end to end encryption wherein symmetric key pair may be generated for encrypting and decrypting the messages using the cryptographic keys encoded to the computer readable medias.

The user may select enhanced security wherein cryptographic key pairs a further generated for the signing and verification of signatures.

In further embodiments, the first computer readable media 101 may be stored digitally on the first electronic device 108 instead of being in a physical form to protect master passwords, private keys and the like.

In yet another embodiment, a shared secret or a password may be exchanged by the users using external methods such as voice calls, SMS, emails, etc. The first computer electronic device 108 and the second electronic device 110 would use the encryption key from the computer readable media 101 and 104 along with this user exchanged shared secret or password for enhanced security and privacy.

In embodiments, the cryptographic keys on the computer readable media may be used to initiate a chat session or an audio/video call. The communication can be encrypted end-to-end either by using the cryptographic keys on the computer readable media or by generating a new key for each session while using the static cryptographic keys just for exchanging new session specific keys.

The foregoing description, for purposes of explanation, used specific nomenclature to provide a thorough understanding of the invention. However, it will be apparent to one skilled in the art that specific details are not required in order to practise the Invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A secure end-to-end messaging system comprising:
first computer readable media in a first location, the first computer readable media encoding a first cryptographic code;
second computer readable media associated with the first computer readable media, the second computer readable media in a second location, the second location being away from the first location, the second computer readable media encoding a second cryptographic code,
a server,
a first electronic device configured to:
read the first cryptographic code;
receive a message via a user interface thereof, wherein the system is configured to encrypt the message to generate an encrypted message using the first cryptographic code and to store the encrypted message on the server;
a second electronic device configured to:
read the second cryptographic code, wherein the system is configured to decrypt the encrypted message using the second cryptographic code; and
display the message on a user interface thereof.

2. The system as claimed in claim 1, wherein the first cryptographic code is the same as the second cryptographic code.

3. The system as claimed in claim 1, wherein the first cryptographic code is cryptographically associated with the second cryptographic code.

4. The system as claimed in claim 1, wherein the second electronic device is further configured to:
send a reply message via a user interface thereof, wherein the system is configured to encrypt the message to generate an encrypted reply message using the second cryptographic code and to store the encrypted reply message on the server; and
wherein the first electronic device is configured to:
read the first cryptographic code, wherein the system is configured to decrypt the encrypted reply message using the first cryptographic code; and
display the reply message on a user interface thereof.

5. The system as claimed In claim 1, wherein the first electronic device configured to:
encrypt the message to generate the encrypted message using the first cryptographic code; and
transmit the encrypted message to the server.

6. The system as claimed in claim 1, wherein the second electronic device is configured to:
receive the encrypted message from the server;
decrypt the encrypted message.

7. The system as claimed in claim 1, wherein the first and second cryptographic codes are a group password or a shared symmetric key.

8. The system as claimed in claim 1, wherein the first computer readable media encodes a master password.

9. The system as claimed in claim 8, wherein the system uses the master password for enabling at least one of:
message part editing permissions; and
message type sending permissions.

10. The system as claimed in claim 1, wherein the first and second computer readable media each encode a group identifier.

11. The system as claimed in claim 1, wherein the first computer readable media encodes message expiration date and wherein the server is configured to delete the encoded message at the message expiration date.

12. The system as claimed in claim 1, wherein the first computer readable media encodes a URL of a resource served by the server.

13. The system as claimed in claim 1, wherein at least one of the first and second cryptographic keys are represented as a fragment of the URL.

14. The system as claimed in claims 7 and 12, wherein the fragment encodes the group password.

15. The system as claimed in claims 8 and 12, wherein the fragment encodes the master password.

16. The system as claimed in claim 12, wherein the URL comprises query string parameters.

17. The system as claimed in claims 10 and 16, wherein the query string parameters encode the group identifier.

18. The system as claimed in claims 11 and 16, wherein the query string parameters encode a message expiration date.

19. The system as claimed in claim 1, wherein the system is configured to obtain an identifier of the second electronic device and wherein the system is configured to transmit a notification of the message to the second electronic device accordingly.

20. The system as claimed in claim 1, wherein the identifier is obtained via the user interface of the first electronic device for the first electronic device or for the second electronic device.

21. The system as claimed in claim 1, wherein the electronic device identifier is encoded in at least one of the first computer readable media and the second computer readable media.

22. The system as claimed in claim 1, wherein system uses asymmetric keys for at least one of encrypting messages, decrypting messages, signing messages and verifying signed messages.

23. The system as claimed in claim 22, wherein the first computer readable media encodes a private key of an asymmetric key pair.

24. The system as claimed in claim 23, wherein the server holds the corresponding public key of the asymmetric key pair and wherein the server is configured to at least one of encrypt the message and/or authenticate the signature of the message.

25. The system as claimed in claim 23, wherein the second computer readable media encodes the corresponding public key of the asymmetric key pair and wherein the second electronic device is configured to at least one of encrypt the message and/or authenticate/verify the signature of the message.

26. The system as claimed in claim 1, wherein the server serves a resource for the generation of the computer readable media.

27. The system as claimed in claim 26, wherein the resource allows specification of the number of computer readable media.

28. The system as claimed in claim 26, wherein the resource allows configuration of permission settings.

29. The system as claimed in claim 26, wherein the server generates the group password.

30. The system as claimed in claim 28, wherein the server generates the master password for the permission settings.

31. The system as claimed in claim 28, wherein the permission settings comprise permission settings for at least one of editing of message parts, messages type and message expiration.

32. The system as claimed in claim 26, wherein the server generates cryptographic key pairs a further generated for the signing of message signatures and verification of the message signatures.

33. The system claimed in claim 22, wherein two asymmetric key pairs are used with one private key on each computer readable media and the corresponding public key on the opposite computer readable media to effectively allow encrypting of messages sent from either of the client electronic devices, which can be decrypted by the receiving device by using the corresponding private key.

34. The system claimed in claim 22, wherein two asymmetric key pairs are used with one private key on each computer readable media and the corresponding public key on the opposite computer readable media to effectively allow signed messages to be sent from either of the client electronic devices, which can be verified by the receiving device by using the corresponding public key.

35. The system claimed in claim 8, wherein the private key of an asymmetric key pair is used as a master password to cryptographically sign the data, allowing the other computer readable media to hold the corresponding public key for signature verification and avoiding the password hash of the master password to be stored on the server.

36. The system claimed in claim 1, wherein an additional shared secret or a password transmitted by the users via another medium such as emails, SMS, voice calls, etc. is used to further secure the communication.

37. The system as claimed in claim 22, wherein the second computer readable media encodes a private key of an asymmetric key pair.

38. The system as claimed in claim 37, wherein the server holds a corresponding public key of the asymmetric key pair and wherein the server is configured to at least one of encrypt the message and/or authenticate the signature of the message.

39. The system as claimed in claim 37, wherein the first computer readable media encodes the corresponding public key of the asymmetric key pair and wherein the first electronic device is configured to at least one of encrypt the message and/or authenticate/verify the signature of the message.

40. The system claimed in claim 1, where more than two computer readable medias are encoded to create a group of encrypted communication channel instead of just two.
